(19) United States
(12) Patent Application Publication
(10) Pub. No.: US 2020/0024424 A1
(43) Pub. Date: Jan. 23, 2020

(54) POLYOLEFIN STABILIZERS WITH REDUCED FRAGMENTATION

(71) Applicant: SONGWON INDUSTRIAL CO., LTD., Ulsan (KR)

(72) Inventor: Klaus KECK, Angleur (BE)

(21) Appl. No.: 16/496,041

(22) PCT Filed: Mar. 20, 2018
(86) PCT No.: PCT/IB2018/051861

§ 371 Date: Sep. 20, 2019

(30) Foreign Application Priority Data
Mar. 22, 2017 (EP) 17162445.5

(51) Int. Cl. C08K 5/134; C08F 110/02; C08K 5/13; C08K 5/524; F16L 9/12

(52) U.S. Cl. CPC C08K 5/1345; C08F 110/02; F16L 9/12; C08K 5/524; C08K 5/13

(57) ABSTRACT

The disclosure relates to a polyolefin composition having a selected thermal and processing stabilizer so that less pollutants emerge from the polyolefin.

### CROSS-REFERENCE TO RELATED APPLICATIONS

This application is a National Phase of International Application No. PCT/IB2018/051861 filed on Mar. 20, 2018. This application claims the benefit of European Patent Application No. 17162445.5, filed on Mar. 22, 2017. The entire disclosures of the above applications are incorporated herein by reference.

### FIELD

The present disclosure relates to a polyolefin composition containing stabilizers and articles made using such polyolefin compositions, such as pipes, packaging, especially food-packaging articles or the like.

### BACKGROUND

This section provides background information related to the present disclosure which is not necessarily prior art.

Recent progress in the manufacturing and processing of polymers has led to the application of plastics in virtually every aspect of modern day life. However, polymeric compounds are prone to aging under the effects of oxidants, light and heat. This results in a loss of lifetime such as loss of strength, stiffness and flexibility, discoloration and scratching as well as loss of gloss.

It is well-known in the art that stabilizers such as antioxidants can prevent or at least reduce these effects. However, since these stabilizers usually have a far lower molecular weight than the polyolefin, a further important issue as regards the presence of antioxidants in polyolefin compositions is the aim to reduce migration of antioxidants or products received therefrom into media e.g. into water in a pipe made of such a polyolefin composition or into food from a packaging article made of such a polyolefin composition.

This is particularly important in case of a pipe transporting drinking water. Due to the permanent contact to the inner pipe surface, compounds can migrate from the pipe material into the water. The admissible amounts of compounds within the drinking water are fixed by legal requirements and even stricter requirements are to be expected in Europe or other countries. This not only goes for the stabilizers as such but to some extent even more for products which arise out of the fragmentation of such stabilizers.

Similar requirements are present in the field of food packaging or food appliances, however, here some difficulties may arise since here also extraction into non-aqueous media plays a role.

### SUMMARY

This section provides a general summary of the disclosure, and is not a comprehensive disclosure of its full scope or all of its features.

It is therefore an object to provide polymer compositions which on the one hand show sufficient stability and on the other hand lead to less release of undesired compounds.

This object is solved by a polymer composition according to Claim 1 of the present disclosure. Accordingly a polyolefin composition is provided, comprising a polyolefin, a radical scavenger and a processing stabilizer, whereby the radical scavenger comprises a compound selected from the group comprising a first compound having a first structure (I)

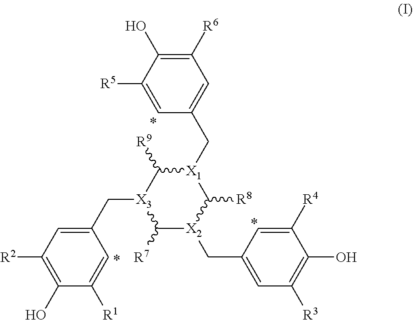

whereby R¹ to R⁶ are independently from each other alkyl, preferably methyl, ethyl, isopropyl, butyl and t-butyl,
R⁷ to R⁹ are independently from each other either alkyl, preferably methyl, or ═O, whereby any of the R⁷ to R⁹ may be connected to the nearest carbon atom marked with “*” to form a six-membered ring,
X¹ to X³ are independently from each other either C or N
and the center ring of the molecule is aromatic;
a second compound selected from a second structure A-B-A whereby A has the following structure:

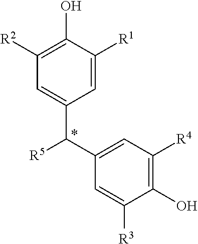

with R¹ to R⁵ being independently selected from either hydrogen or alkyl, preferably methyl, ethyl, propyl, n-butyl, t-butyl, provided that one of R¹ and R² as well as one of R³ and R⁴ is not hydrogen and whereby A and B are connected via the carbon marked as “*”
and B selected from the group comprising an alkyl bridge having two to six carbon atoms or —[CH₂]ₙ—C═X—O—[CH₂]ₘ—O—C═X—[CH₂]ₙ— with n being an integer from to 0 to 4, X either being O, S or two hydrogen atoms and m being an integer from 2 to 6.
or mixtures thereof
and the processing stabilizer essentially does not contain a hydrolizable phosphite compound having a 2-4-substituted phenol moiety.

The term phosphite (or phosphonite) means and/or relates to the major chemical class of processing stabilizers utilized in polyolefins. An overview over typical molecules is given on page 109 to 112 of the Plastics Additive Handbook (Hanser Publishers, 5^{th} Edition (2001)). It can be noted that the preferred subclass within phosphites comprised 2-4-substituted phenol moieties. The principle chemistry and advantages of this chemical class are outlined on page 14 of the same reference. Also noted (on the same page) is the principle weakness of this chemical class; being its sensitivity to hydrolysis.

The term “hydrolizable phosphite” especially means and/or relates to the effect described on the bottom of page 45 and on the bottom of page 47 (of the above publication). While there is a difference in the rate of hydrolysis, yielding at different rates fragmentation products, it is generally accepted that all commonly used phosphites do hydrolysis.

Surprisingly it has been found that by using such a polyolefin composition the detectable pollutants, especially arising from a fragmentation of the stabilizers, are significantly reduced for most applications, while still providing a suitable stability of the polyolefin.

The present disclosure furthermore relates to a use of a stabilizer composition, comprising a radical scavenger comprising a compound selected from the compound (I) and (II) or mixtures thereof and a processing stabilizer which essentially does not contain 2-4-substituted phenol moiety for reducing the amount of pollutants.

The present disclosure furthermore relates to a use of a stabilizer composition, comprising a radical scavenger comprising a compound selected from the compound (I) and (II) or mixtures thereof and a processing stabilizer which essentially does not contain 2-4-substituted phenol moiety for reducing the amount of pollutants resulting from the fragmentation of the stabilizer composition.

The term “polyolefin” according to the present disclosure especially means and/or includes all substrates as defined in US 2015/0090671 A1, US 2014/0296398 A1, WO 2006/119935 A1 and/or US 2005/0148700 A1.

The term “fragmentation” in the sense of the present disclosure especially relates and/or includes all processes where the initial components of the stabilizer composition yield intentional or un-intentional transformation products which are of low enough molecular weight as to potentially being physically lost from the polyolefin substrate. The chemical nature of the fragment can vary significantly and is not limited the phenol derivatives.

Fragmentation can occur through e.g. but is not limited to hydrolysis, C—C-bond cleavage, intended reaction of the stabilizer, side reactions, shear force induced fragmentation of the stabilizer as well as interaction with other additives.

The individual stabilizers and components for these stabilizers will be discussed in more detail, whereby any of the features can be combined ad libitum:

### Radical Scavenger:

The term “radical scavenger” according to the present disclosure especially means and/or includes a compound which protects the polyolefin in the solid state from auto-oxidation. Radical scavangers can potentially as well interact and function during the melt-conversion of polyolefins.

According to the disclosure, the radical scavenger comprises a compound selected from the compound (I) and (II) or mixtures thereof. According to a preferred embodiment of the present disclosure, the radical scavenger consists essentially of a compound selected from the compound (I) and (II) or mixtures thereof.

The term “consisting essentially of” in the sense of the present disclosure especially means and/or includes (in wt/wt) ≥95%, more preferred ≥98% and most preferred ≥99%.

The term “essentially not containing” in the sense of the present disclosure especially means and/or includes (in wt/wt/ ≤1%, more preferred ≤0.1%, yet more preferred ≤0.01% and most preferred ≤0.001%.

### Compound (I)

According to a preferred embodiment of the present disclosure, R¹ to R⁶ are independently from each other methyl and t-butyl.

However, according to a preferred embodiment of the disclosure, all R¹ to R⁶ are t-butyl.

According to an alternative preferred embodiment of the disclosure, on one ring on R is methyl and the other is t-butyl.

According to a preferred embodiment of the present disclosure, all X¹ to X³ are C and all R⁷ to R⁹ are alkyl.

According to an alternative preferred embodiment of the present disclosure, all X¹ to X³ are N and all R⁷ to R⁹ are ═O.

According to a preferred embodiment of the present disclosure, the Compound (I) is selected from the group comprising:

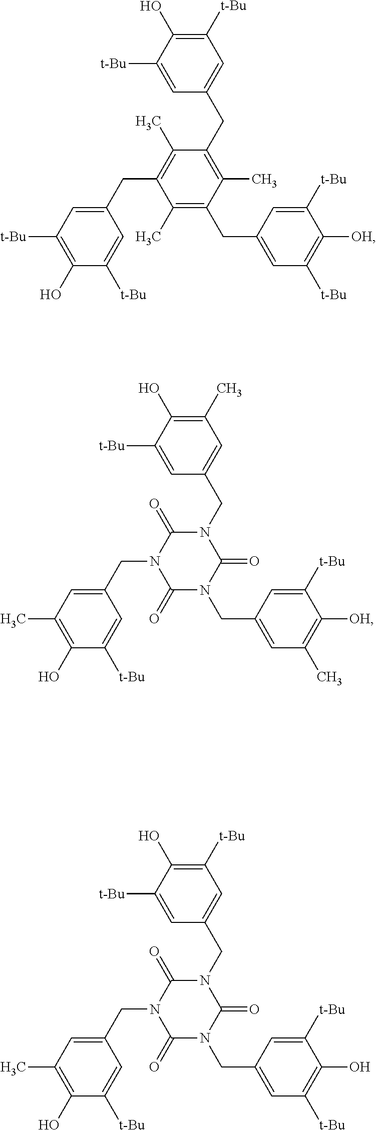 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1 ; Cc1cc(Cn2c(=O)n(Cc3cc(C)c(O)c(C(C)(C)C)c3)c(=O)n(Cc3cc(C)c(O)c(C(C)(C)C)c3)c2=O)cc(C(C)(C)C)c1O ; Cc1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

or mixtures thereof.

### Compound (II)

According to a preferred embodiment, one R¹ and R² is hydrogen, the other is t-butyl.

According to a preferred embodiment, one R³ and R⁴ is hydrogen, the other is t-butyl.

According to a preferred embodiment, R⁵ is not hydrogen, preferably R⁵ is methyl.

Preferably the moiety “B” is —[CH₂]ₐ—C═O—O—[CH₂]_{b}—O—C═O—[CH₂]ₐ— with a=0 or 1 and b 2 or 4.

According to a preferred embodiment of the present disclosure, Compound (II) includes, preferably consist essentially of the following compound:

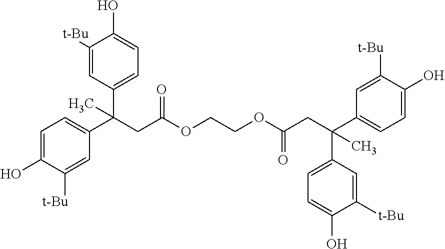 [SMILES: CC(C)(C)c1cc(C(C)(CC(=O)OCCOC(=O)CC(C)(c2ccc(O)c(C(C)(C)C)c2)c2ccc(O)c(C(C)(C)C)c2)c2ccc(O)c(C(C)(C)C)c2)ccc1O]

### Processing Stabilizer:

The term “processing stabilizer” according to the present disclosure especially means and/or includes a compound which protects the polyolefin in the molten state from auto-oxidation. Processing stabilizers can, depending on the application and/or preferred embodiment and/or their chemical nature either act alone or as synergist to selected “radical scavengers”.

According to a preferred embodiment of the present disclosure, the processing stabilizer comprises, preferably consists essentially of a compound selected out of the group comprising phosphites (without a 2,4-substituted phenol moiety), phosphonites (without a 2,4-substituted phenol moiety), N-hydroxylamines, natural antioxidants, especially selected from the group comprising curcumin, quercetin, naringenin, beta-carotin, resveratrol, Vitamin E and derivatives of all these compounds, cyclic pentaerythritole diphosphite esters, partially unsaturated hydrocarbons or mixtures thereof.

### Acid Scavenger:

According to a preferred embodiment, the polyolefin further comprises an acid scavenger. Consequently the present disclosure also relates to the use of a stabilizer composition as described above together with an acid scavenger.

The term “acid scavenger” according to the present disclosure especially means and/or includes a compound which neutralizes acidity which may originate from the polymerisation catalyst of the polyolefin synthesis; usually this will be mainly Ziegler/Nata catalysts. It is understood, that not every catalyst used for polyolefin synthesis requires an acid scavenger.

According to a preferred embodiment of the present disclosure, the acid scavenger comprises, preferably consists essentially of a metal oxide, metal hydroxide, metal organic salt and/or metal carbonate.

Preferably the acid scavenger comprises a layered double hydroxide compound.

Layered double hydroxides (LDHs) in the sense of the present disclosure are defined as layered materials with positively charged layers and charge balancing anions located in the interlayer region. This is unusual in solid state chemistry as many more families of materials have negatively charged layers and cations in the interlayer spaces (e.g. kaolinite, Al₂Si₂O₅(OH)₄).

Usually the layered double hydroxides (LDHs) are compounds according to the following formula

[M^{II}₁₋ₓM^{III}₁₋ₓ(OH)₂]^{x+}(Aⁿ⁻)_{x/n}.yH₂O

wherein

M^{II} is a divalent metal ion, preferably Mg²⁺, Ca²⁺, Mn²⁺, Fe²⁺, Zn²⁺, Cu²⁺, Ni²⁺ and Co²⁺;

M^{III} is a trivalent metal ion, preferably Al³⁺, Cr³⁺, Fe³⁺, Ga<3+> and Mn³⁺,

Aⁿ⁻ is an anion, preferably Cl⁻, CO3²⁻, NO3⁻, Br⁻, SO4²⁻ and alkyl sulfonates, alky aryl sulfonates, organic carboxylates, organic phosphates or mixtures thereof, more preferably Cl⁻,
CO3²⁻, NO3⁻, Br⁻, SO₄²⁻ or mixtures thereof
whereby n is the number of negative charges, e. g. in case of Cl⁻ n=1 and in case of CO3²⁻ n=2, usually n is within the range of 1 to 2;
y is number of water molecules needed to stabilize the crystal structure, usually y is within the range of 0.25 to 4, preferably 0.5 to 4, more preferably 0.5 to 1.0;
x is usually within the range of 0.1 to 0.5, preferably within the range of 0.10 to 0.38, more preferably within the range of 0.10 to 0.33;

Layered double hydroxides (LDHs) are inter alia described in F. Cavani, F. Trifiro, A. Vaccari, Catal. Today 1991, 11, 173) which is herewith incorporated by reference.

In case Aⁿ⁻ is an alkyl sulfonate, the alkyl group is usually a C1 to C20 alkyl group.

In case Aⁿ⁻ is an alky aryl sulfonate the alky aryl group is a C6 to C20 alky aryl group.

In case Aⁿ⁻ is an organic carboxylate, the organic group attached to the carboxylate group(s) usually contains 1 to 20 carbon atoms and up to 5 heteroatoms, preferably, if present, the heteroatoms are selected from N, O, P and S. Usually the organic carboxylate comprises 1 to 2 carboxylate groups, preferably 1 carboxylate group.

The term “organic group attached to the carboxylate group(s)” denotes that the carboxylate groups are not part of the organic group. Thus, the oxygen and carbon atoms present in the carboxylate group do not count for the organic group. Thus, for example in case of acetate, the organic group is methyl.

In case Aⁿ⁻ is an organic phosphate the organic group(s) attached to the phosphate group(s) independently usually contains 1 to 20 carbon atoms and up to 5 heteroatoms, preferably, if present, the heteroatoms are selected from N, O, P and S. Usually the organic phosphate comprises one phosphate group and one organic group.

The term “organic group(s) attached to the phosphate group(s)” denotes that the phosphate groups are not part of the organic group(s). Thus, the oxygen and phosphor atoms present in the phosphate group do not count for the organic group. Thus, for example in case of methyl phosphate the organic group is methyl.

Preferably, in the layered double hydroxides (LDHs) are compounds according to the following formula

[M^{II}₁₋ₓM^{III}₁₋ₓ(OH)₂]^{x+}(Aⁿ⁻)_{x/n}.yH₂O

M^{II} is selected from Mg²⁺, Ca²⁺ or Zn²⁺;
M^{III} is Al³⁺;
Aⁿ⁻ is an anion selected from Cl⁻, CO3²⁻ and NO3⁻
y is within the range of 0.25 to 4, preferably within the range of 0.5 to 1.0
x is within the range of 0.10 to 0.38, preferably within the range of 0.10 to 0.33,

More preferably, the layered double hydroxides (LDHs) is selected from synthetic hydrotalcit

Mg_{4.5}Al₂(OH)₁₃(CO3)_{3.5}.H₂O (CAS-no. 11097-59-9)

or
hydrotalcit

Mg₆Al₂(OH)₁₆(CO₃).4H₂O.

Especially preferred are hydrotalcite, hydrocalumite, metal fatty acids, zink oxide and calcium carbonate.

Surprisingly it has been found that layered double hydroxides, such as hydrotalcite is especially advantageous as a stabilizer. Therefore the present disclosure especially relates to a polyolefin composition, comprising a polyolefin, a radical scavenger and a processing stabilizer as described above and a layered double hydroxide.

The above effect of layered double hydroxides was surprisingly as well observed in cases where the polyolefin was manufactured with a catalyst system that does not yield acidic catalyst residues and hence normally the use of acid scavengers is not required.

The present disclosure furthermore relates to a product comprising an inventive polyolefin and/or a product making use of the inventive use.

According to a preferred embodiment, the product comprises a product selected from the group comprising:

Pipes,

Rigid food packaging,

Flexible food packaging,

Food appliances.

It should be noted that depending on the application, the total content of stabilizer in the polyolefin composition may vary.

Whereas polyolefin compositions which are intended for a long-term use, such as pipes usually require a larger content of radical scavengers, in other applications, such as food-packaging, the content of radical scavengers may be lower.

The present disclosure therefore relates to a polyolefin composition according to the present disclosure whereby the content of the radical scavenger is ≥1000 μm.

The present disclosure also relates a use of a stabilizer composition, comprising a radical scavenger comprising a compound selected from the compound (I) and (II) or mixtures thereof and a processing stabilizer which essentially does not contain 2-4-substituted phenol moiety for reducing the amount of pollutants resulting from the fragmentation of the stabilizer composition in polyolefin compositions whereby the added content of radical scavenger and processing stabilizer is ≥1000 μm.

Preferably the content of the radical scavenger is ≥1500 μm, more preferred ≥2000 ppm.

Additionally and alternatively, the present disclosure therefore relates to a polyolefin composition according to the present disclosure whereby the content of the radical scavenger is ≤1000 μm.

The present disclosure also relates a use of a stabilizer composition, comprising a radical scavenger comprising a compound selected from the compound (I) and (II) or mixtures thereof and a processing stabilizer which essentially does not contain 2-4-substituted phenol moiety for reducing the amount of pollutants resulting from the fragmentation of the stabilizer composition in polyolefin compositions whereby the content of the radical scavenger is ≤1000 μm.

Preferably the content of the radical scavenger is ≤800 μm, more preferred ≤500 ppm.

The aforementioned components, as well as the claimed components and the components to be used in accordance with the disclosure in the described embodiments, are not subject to any special exceptions with respect to their size, shape, material selection and technical concept such that the selection criteria known in the pertinent field can be applied without limitations.

Additional details, characteristics and advantages of the object of the disclosure are disclosed in the subclaims and the following description of the respective figures—which in an exemplary fashion—show one preferred embodiment according to the disclosure. Such embodiment does not necessarily represent the full scope of the disclosure, however, and reference is made therefore to the claims and herein for interpreting the scope of the disclosure. It is to be understood that both the foregoing general description and the following detailed description are exemplary and explanatory only and are intended to provide further explanation of the present disclosure as claimed.

### Description of the Extraction Tests:

### Polyolefin:

The experimental tests which are described further on were conducted with a LLPDE grade polyolefin. It is a Ziegler/Natta catalyzed polyethylene manufactured after UNIVATION fluidized bed gas phase polymerization. Its melt flow index MFI_{2.16/190} is 0.9 [g/10 min] and its density 0.918 [g/cm³]. Its physical form is fine powder.

### Sample Preparation:

The compounding of the LLDPE took place using a Toshiba TEM 37BS twin screw extruder with a temperature profile from 190° C. to 215° C. under nitrogen. In order to match or at least simulate the processing conditions of industrial equipment, this extrusion was repeated five times.

### Migration Test:

The migration tests were performed using the following standard procedure.

10 g of the sample (polyethylene granules) are immersed in 100 ml of water. The mixture is stirred at room temperature for 72 hours. Subsequently, the polyethylene granules are decanted off and the aqueous extract is subjected to GC-MS analysis.

### Melt Flow Index (MFI_{Weight/Temperature})

The melt flow index is a very crude (but simple and practical) rheological measurement of the flow behavior of polymer melts at a given temperature and for one single, given shear rate. It is proportional to the molecular weight of the polymer. An increase in melt flow index corresponds to a decrease in molecular weight due to chain scission, while a decrease in melt flow index corresponds to an increase in molecular weight due to crosslinking reactions.

MFI measurement were carried in accordance with ISO1133 on a semi-automatic Ceasit 16412.

### Yellowness Index (YI)

The yellowness index is a measure of the discoloration of a (plastic) material with specific emphasis on the yellowing (in contrast to whiteness index and total color change). It is calculated according to the following equation

$$YIE 313 = \frac{100 ( {C}_{x} X - {C}_{Z} Z )}{Y}$$

$$YID 1925 = \frac{100 ( 1.274976795 X - 1.058398178 Z )}{Y}$$

YI measurement were carried out in accordance with ISO E 313 on a Greytag Macbeth Spectro Eye. For productivity reasons, YI is measured on polyethylene granules rather than on moulded plaques; although the latter yield more precise results.

Seven comparative samples (C.1 to C.6) and two inventive samples (I.1 and I.2) were investigated. The composition is as follows:

| Sample | Composition |
|---|---|
| C.1 | No antioxidant |
| C.2 | 1000 ppm of |
| | 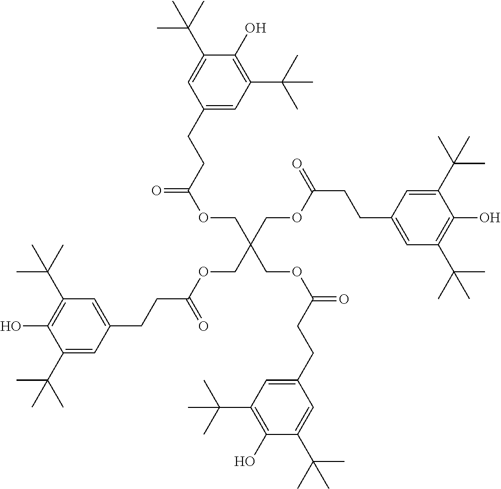 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O] |
| C.3 | 1000 ppm of |
| | 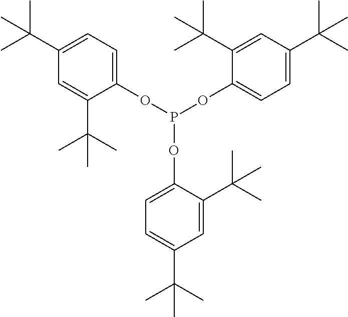 [SMILES: CC(C)(C)c1ccc(OP(Oc2ccc(C(C)(C)C)cc2C(C)(C)C)Oc2ccc(C(C)(C)C)cc2C(C)(C)C)c(C(C)(C)C)c1] |
| C.4 | 500 ppm of C.2 + 500 ppm of C.3 |
| C.5 | Added stabilizer (1000 ppm): |
| | 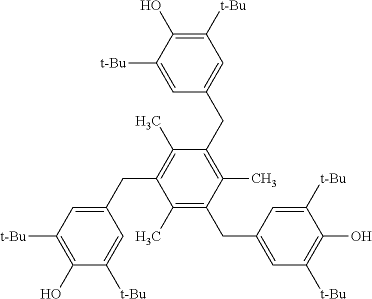 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1] |
| C.6 | Added Stabilizer (1000 ppm) |
| | 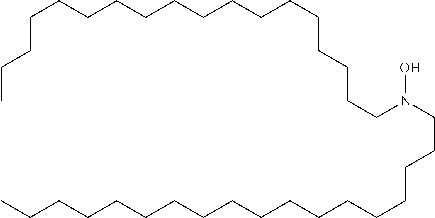 [SMILES: CCCCCCCCCCCCCCCCCCN(O)CCCCCCCCCCCCCCCCCC] |
| C.7 | Added Stabilizer (1000 pm): Vitamin E |
| I.1 | Added Stabilizer: 500 ppm |
| | 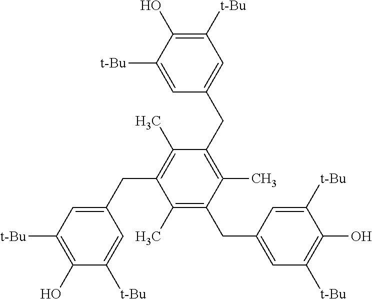 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1] |
| | additionally 500 ppm |
| | 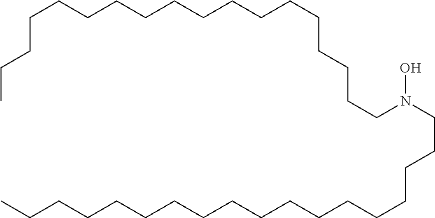 [SMILES: CCCCCCCCCCCCCCCCCCN(O)CCCCCCCCCCCCCCCCCC] |
| I.2. | Added Stabilizer: 500 ppm |
| | 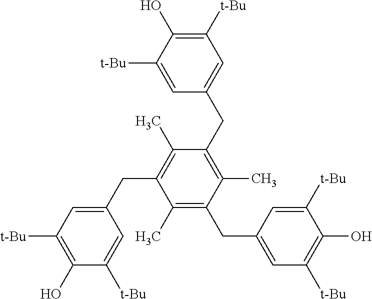 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1] |
| | And 500 ppm Vitamin E |

All samples furthermore included 750 ppm of calcium stearate.

The results are given in the table below:

| | | | | | | Concentration |
|---|---|---|---|---|---|---|
| | | | | | | of |
| | | | | | | quantifiable |
| Sam- | Extrusion | | | Dura- | No. of | frag- |
| ple | Pass | MFI | YI | bility | Fragments | ments [ppb] |
| C.1 | 0 | 0.70 | | | | |
| | 5 | 0.32 | 0.5 | No | high | |
| C.2 | 0 | 0.78 | | | 6 | 375 |
| | 5 | 0.53 | 7.5 | Yes | 7 | 503 |
| C.3 | 0 | 0.92 | | | 3 | 100 |
| | 5 | 0.52 | −3.6 | No | 4 | 240 |
| C.4 | 0 | 0.81 | | | 2 | 60 |
| | 5 | 0.58 | 6 | Yes | 9 | 12650 |
| C.5 | 0 | 0.76 | | | 2 | 30 |
| | 5 | 0.52 | 11.4 | Yes | 4 | 330 |
| C.6 | 0 | 0.85 | | | 1 | 70 |
| | 5 | 0.59 | −3.8 | No | 3 | 0 |
| I.1 | 0 | 0.81 | | | 1 | 30 |
| | 5 | 0.54 | 0.8 | Yes | 7 | 800 |
| C.7 | 0 | 0.75 | | | 2 | 100 |
| | 5 | 0.48 | 26.4 | No | 2 | 0 |
| I.2 | 0 | 0.75 | | | 1 | 40 |
| | 5 | 0.46 | 17.8 | Yes | 5 | 210 |

Durability was considered “Yes” if the service life exceeds 3 months at 50° C.

Sample C.1. (=unstabilized) gave a high number of fragments resulting from the polyolefin itself. For the other samples the fragments were believed to be due to the fragmentation of the stabilizers.

In Sample C.1 the MFI of 0.32 is considered to low and unacceptable.

Comparative example C.1 demonstrates that polyolefins cannot be processed without antioxidants. The polymer loses its mechanical properties and volatile and extractable compounds are formed (polymer originating NIAS; None Intentional Added Substances).

Any of the added stabilizers does protect the polyolefin from degradation during melt conversion. However, thermal stabilizers alone (C.2 and C.5), while providing additionally durability do cause in general a discolouration of the substrate. A Yellowness index of 7.5 or more is also unacceptable. Processing stabilizers alone (C.3, C.6 & C.7) do not render the substrate suitable for medium and longterm applications. Comparative example C.4 protects the substrate during melt conversion from auto-oxidation without generating too much colour and renders the material suitable for durable applications. However, a significant number and amount of fragments can be detected in the sample.

Only the inventive example I.1 and 1.2 protect the polyolefin during melt conversion in a sufficient way without causing an unacceptable number of detectable fragmentation products.

In order to investigate the advantageous role of the hydrotalcite, the following experiments were performed: To a composition according to example C2 containing 1000 ppm of radical scavenger (but no calcium stearate), the additives according to the table below were added in an amount of 400 ppm. The amount of 2,6, Di-tert. butyl-1,4, benzoquinone was measured by GC-MS in terms of peak area and peak height after the above described extraction test.

| Additive | Peak area | Peak height |
|---|---|---|
| — | 72155 | 19293 |
| DHT-4a (synthetic hydrotalcite) | 65223 | 17448 |
| DHT-4a coated by stearic acid | 65451 | 17498 |
| Dried DHT-4a | 66135 | 17610 |

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the disclosure as claimed. Accordingly, the foregoing description is by way of example only and is not intended as limiting. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. The disclosure's scope is defined in the following claims and the equivalents thereto. Furthermore, reference signs used in the description and claims do not limit the scope of the disclosure as claimed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A polyolefin composition, comprising a polyolefin, a radical scavenger and a processing stabilizer, whereby the radical scavenger comprises a compound selected from the group comprising a compound having a first structure (I) 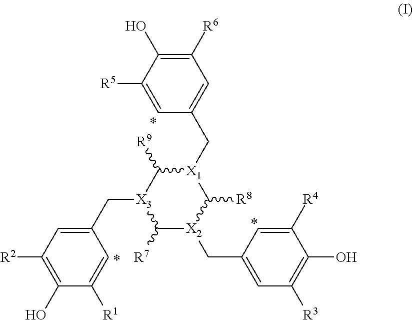
whereby R¹ to R⁶ are independently from each other alkyl, preferably methy, ethyl, isopropyl, butyl and t-butyl,
R⁷ to R⁹ are independently from each other either alkyl, preferably methyl, or ═O, whereby any of the R⁷ to R⁹ may be connected to the nearest carbon atom marked with “*” to form a six-membered ring,
X¹ to X³ are independently from each other either C or N
and the center ring of the molecule is aromatic;
a compound selected from a second structure A-B-A whereby A has the following structure: 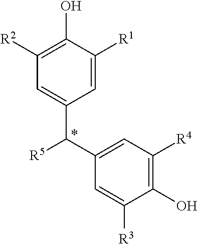
with R¹ to R⁵ being independently selected from either hydrogen or alkyl, preferably methyl, ethyl, propyl, n-butyl, t-butyl, provided that one of R¹ and R² as well as one of R³ and R⁴ is not hydrogen and whereby A and B are connected via the carbon marked as “*”
and B selected from the group comprising an alkyl bridge having two to six carbon atoms or —[CH₂]ₙ—C═X—O—[CH₂]ₘ—O—C═X—[CH₂]ₙ— with n being an integer from to 0 to 4, X either being O, S or two hydrogen atoms and m being an integer from 2 to 6.
or mixtures thereof
and the processing stabilizer essentially does not contain a hydrolizable
phosphite compound having 2-4-substituted phenol moiety.

2. The polyolefin composition according to claim 1, whereby in structure (I) R¹ to R⁶ are independently from each other methyl and t-butyl.

3. The polyolefin composition according to claim 1, furthermore comprising an acid scavenger.

4. The polyolefin composition according to claim 1, whereby the processing stabilizer comprises a compound selected out of the group comprising phosphites (without a hydrolizable 2,4-phenyl moiety), phosphonites (without a hydrolizable 2,4-phenyl moiety), N-hydroxylamines, natural antioxidants, cyclic pentaerythritole diphosphite esters, partially unsaturated hydrocarbons or mixtures thereof

5. The polyolefin composition according to claim 1, whereby the radical scavenger is selected from the group comprising: 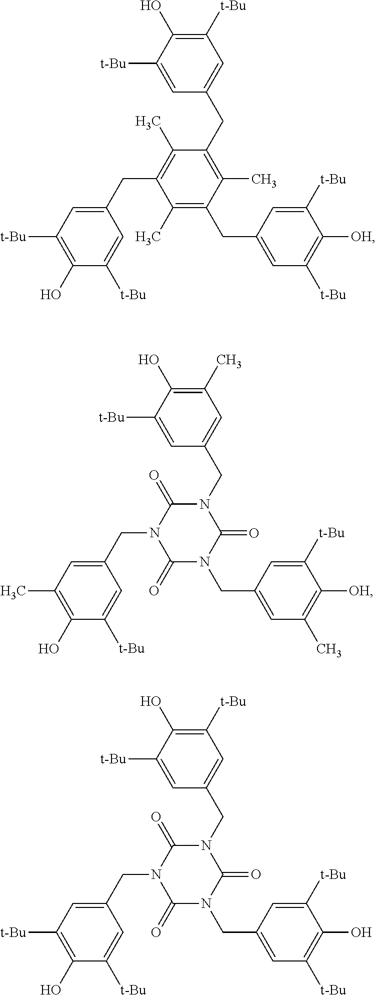 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1 ; Cc1cc(Cn2c(=O)n(Cc3cc(C)c(O)c(C(C)(C)C)c3)c(=O)n(Cc3cc(C)c(O)c(C(C)(C)C)c3)c2=O)cc(C(C)(C)C)c1O ; CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]
or mixtures thereof.

6. The polyolefin composition according to claim 1, whereby the radical scavenger includes the following compound:

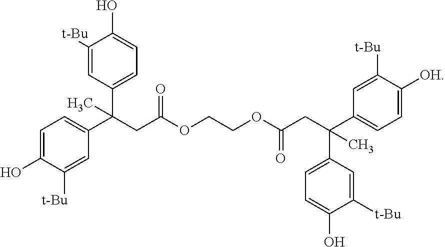 [SMILES: CC(C)(C)c1cc(C(C)(CC(=O)OCCOC(=O)CC(C)(c2ccc(O)c(C(C)(C)C)c2)c2ccc(O)c(C(C)(C)C)c2)c2ccc(O)c(C(C)(C)C)c2)ccc1O]

7. The polyolefin composition according to claim 1, furthermore comprising an acid scavenger comprising a layered double hydroxide compound.

8. The polyolefin composition according to claim 1, whereby the content of the radical scavenger is ≥1000 μm.

9. The polyolefin composition according to claim 1, whereby the content of the radical scavenger is ≤1000 μm.

10. Use of a stabilizer composition, comprising a radical scavenger comprising a compound selected from the compound (I) and (II) or mixtures thereof and a processing stabilizer which essentially does not contain a hydrolizable phosphite compound having 2-4-substituted phenol moiety, in polyolefins for reducing the amount of pollutants.

11. Use of a stabilizer composition, comprising a radical scavenger comprising a compound selected from the compound (I) and (II) or mixtures thereof and a processing stabilizer which essentially does not contain 2-4-substituted phenol moiety for reducing the amount of pollutants resulting from the fragmentation of the stabilizer composition.

12. A product comprising a polyolefin according to claim 1, the product being selected out of:
Pipes,
Rigid food packaging,
Flexible food packaging, or
Food appliances.
